(19) United States
(12) Patent Application Publication
(10) Pub. No.: US 2023/0127320 A1
(43) Pub. Date: Apr. 27, 2023

(54) External Determination of Control Tactics for Autonomous Vehicles

(71) Applicant: Siemens Aktiengesellschaft, Muenchen (DE)

(72) Inventor: Oliver GRÄBNER, Neustadt a.d. Aisch (DE)

(21) Appl. No.: 17/910,315

(22) PCT Filed: Mar. 2, 2021
(86) PCT No.: PCT/EP2021/055139

§ 371 Date: Sep. 8, 2022

(30) Foreign Application Priority Data
Mar. 10, 2020 (DE) 102020203042.1

(51) Int. Cl. B60W 60/00; B60W 40/04; G08G 1/16

(52) U.S. Cl. CPC B60W 60/001; B60W 40/04; G08G 1/166; B60W 2556/40

(57) ABSTRACT

A method and system for autonomously controlling an autonomous vehicle, wherein the system includes a stationary detector device for statically generating object information from an environment of the detector device and includes a stationary planning device which is configured to determine a statically generated driving tactic for the autonomous vehicle based on the object information, where the autonomous vehicle has a mobile strategy unit for generating a driving strategy of the autonomous vehicle and a mobile planning unit for determining a driving tactic based on the predefined driving strategy, a current driving situation around the autonomous vehicle, and the driving tactic determined by the stationary planning device.

### CROSS-REFERENCE TO RELATED APPLICATIONS

This is a U.S. national stage of application No. PCT/EP2021/055139 filed 2 Mar. 2021. Priority is claimed on German Application No. 10 2020 203 042.1 filed 10 Mar. 2020, the content of which is incorporated herein by reference in its entirety.

### BACKGROUND OF THE INVENTION

### 1. Field of the Invention

The invention relates autonomous vehicle systems and, more particularly to a method and system for autonomously controlling a vehicle.

### 2. Description of the Related Art

Autonomous driving is currently being applied to an ever-greater extent both in private and public transport. However, autonomous control systems are not sufficiently safe in complex traffic situations. Consequently, a monitoring person, who can intervene in the control of the vehicle in the event of misinterpretation by the autonomous control system, is still necessary. Particularly complex situations occur in inner-city intersection situations.

Normally, an autonomously controlled vehicle selects a driving strategy or a driving strategy specified for the vehicle. The driving strategy describes the driving route from a starting point of the vehicle to an end point and comprises instructions that contain the direction of travel or changes of direction of the vehicle and distances between two changes of direction. For example, such information can include the instruction: “Follow the road for 500 m and then turn left.”

Using tactical planning, however, an autonomously controlled vehicle tries to implement the driving strategy in the current traffic situation. This requires information about its own state, also called the ego state, such as its own position, also called the ego position, the vehicle trajectory, and the vehicle speed vector. In addition, detailed information about the road conditions are required, such as the lane width, the turning connections and the number of lanes, which are supplied by an HD map. The vehicle detects the current traffic situation with the aid of its sensor system. Based on the data collected, the vehicle then determines a driving tactic for a specific situation. This driving tactic may include, for example, the following instruction: “Free driving at maximum permitted speed, follow the vehicle ahead, overtake, turn left or right, etc.”. With the aid of a so-called “motion control program”, the tactical planning of the vehicle is then converted into control variables for the drive unit, the brakes, and the steering. However, as inner-city traffic situations are extremely complex and diverse, the tactical planning for a vehicle is much more difficult in such a location than in road areas with restricted traffic conditions, such as a freeway.

Up to now, conventional autonomous control systems have operated with tactical planning algorithms in the vehicle. The vehicle has a set of tactical behaviors learned from many individual driving maneuvers, and uses these tactics in appropriate situations. One disadvantage of this is that the vehicle can only ever make the tactical decision from its limited ego perspective with the information available to it and the learned programmed tactics.

There are also approaches to an infrastructure-supported automated driving system, such as that applied, for example, in the research project OTS 1.0 “Optimized transport system based on autonomous electric vehicles”. Such a system is illustrated in FIGS. 1.

In that system the environment model of the current traffic situation is extended to include information from the infrastructure. The vehicle can therefore look around corners. In this context, reference should also be made to DE 102015 206 439 A1. This system improves traffic safety and traffic flow by extending the field of view of the autonomous vehicle beyond the on-board sensors. However, this does not solve the problem of the limited tactical decision-making possibilities of the planning algorithms in the vehicle.

### SUMMARY OF THE INVENTION

In view of the foregoing, it is therefore and object of the invention to provide a method and system for adapting the driving behavior of an autonomous vehicle to a complex traffic situation.

This and other objects and advantages are achieved in accordance with the invention by a method and system for autonomously controlling an autonomous vehicle, where the system for autonomously controlling an autonomous vehicle in accordance with the invention comprises a static detector device for statically generating object information from an environment of the detector device, and a static planning device that is configured to determine a statically generated driving tactic for the autonomous vehicle based on the object information. For example, object information can include information about the nature or type of the object, the dimensions of the object, possibly dynamic variables, such as its speed and direction of motion, and its function. In this context, “static(ally)” is intended to mean that the object information and the tactical planning process are not performed by a mobile vehicle, but on the infrastructure side. The object information is thus acquired by detectors in a static area, which also does not change.

The autonomous vehicle is also part of the system in accordance with the invention for autonomously controlling an autonomous vehicle. The autonomous vehicle comprises a mobile strategy unit for generating a driving strategy of the autonomous vehicle. Furthermore, the autonomous vehicle comprises a mobile planning unit for determining a driving tactic. The driving tactic of the autonomous vehicle is determined based on a predefined driving strategy, a current driving situation around the autonomous vehicle, and based on the driving tactic determined by the static planning device. The vehicle can select, for example, in accordance with predetermined criteria, from a statically determined driving tactic and a driving tactic determined by the vehicle itself. The criteria can include, for example, safety, time required to reach a destination, or economic or environmental aspects.

Due to the static tactical planning, tactical plans formulated based on information derived from traffic situations that are remote from the autonomous vehicle can be advantageously used. This allows for a more anticipatory tactical planning. The driving tactic can be selected on a location-specific basis. For example, a driving tactic suitable for a first intersection may not be suitable for a second intersection. As the driving tactic is determined statically, it can be more easily adapted to the static conditions.

In the method in accordance with the invention for autonomously controlling an autonomous vehicle, object information from an environment of a static detector unit is statically generated. Furthermore, successful driving tactics are statically determined based on the object information via machine learning and the successful driving tactics are deployed for static tactical planning. In addition, a driving tactic for the autonomous vehicle is statically determined based on the object information and the successful driving tactics. In addition, as part of the method in accordance with the invention, a mobile determination of a driving tactic of the autonomous vehicle is performed based on a predefined driving strategy and also based on data acquired by mobile sensors and based on the statically determined driving tactic. The final driving tactic can be determined, for example, by making a selection from a mobile-determined driving tactic and one or more statically determined driving tactics available for selection. The method in accordance with the invention for autonomously controlling an autonomous vehicle shares the advantages of the system in accordance with the invention for autonomously controlling an autonomous vehicle.

A largely software-based implementation has the advantage that even previously used systems for autonomously controlling an autonomous vehicle can be easily retrofitted via a software update in order to function in the same way as the invention. In this regard, the object is also achieved by a corresponding computer program product having a computer program which can be loaded directly into a storage device of a system for autonomously controlling an autonomous vehicle, having program sections to execute all steps of the method in accordance with the invention when the computer program is executed in the system. Such a computer program product can comprise, in addition to the computer program, additional contents such as documentation and/or additional components, including hardware components such as hardware keys (dongles, etc.) for using the software.

To transport the storage device of the system for autonomously controlling an autonomous vehicle or for storage in or in the storage device, a computer-readable medium, such as a memory stick, a hard disk or any other portable or permanently installed data medium can be used, which stores the program sections of the computer program that can be read in and executed by a computer unit of the system. For example, the computer unit may have one or more cooperating processors, microprocessors or the like for this purpose.

In one embodiment of the system in accordance with the invention for autonomously controlling an autonomous vehicle, the static planning device comprises a learning unit that generates successful driving tactics based on the object information via machine learning. The static planning device also comprises a static planning unit, which determines a statically generated driving tactic for the autonomous vehicle based on the successful driving tactics. Advantageously, particularly suitable driving tactics for a particular local region can be automatically learned and made available for tactical planning. The tactical planning unit then only needs to select a particularly suitable tactic for a current traffic situation from the available tactics. This means that the static, machine-learning based development of driving tactics can achieve improvements in the driving tactic of an autonomous vehicle.

The autonomous vehicle preferably comprises a mobile, on-board traffic situation analysis unit, which is configured to determine the current traffic situation around the autonomous vehicle based on the object information generated by the static detector unit. Advantageously, traffic situations identified in different regions can be used collectively as a basis for tactical planning, thereby further improving the tactical planning. In addition, this results in a certain redundancy in the information processing for tactical planning, which increases the safety of autonomous driving.

Particularly preferably, the static planning device comprises a static traffic situation analysis unit, which is configured to determine a current traffic situation in the region of the static detector unit based on the object information generated by the static detector unit and to transmit information about the current traffic situation to the static planning unit. The traffic situation is determined based on the available information about the infrastructure and its surroundings. For example, the determination of the traffic situation includes information about individual objects in the vicinity of the infrastructure. The traffic situation serves as the basis for determining a suitable driving tactic. The current traffic situation outside of the field of vision of an autonomous vehicle can also be advantageously taken into account for tactical planning, making a more anticipatory driving style possible and increasing safety for all road users.

In a preferred embodiment of the system in accordance with the invention for autonomously controlling an autonomous vehicle, the autonomous vehicle comprises a mobile map unit, which is configured to provide the mobile planning unit with map data for determining the current traffic situation around the autonomous vehicle. In addition to the information about the current traffic situation and the ego state of the autonomous vehicle, the map data serves as the basis for the driving tactics planning of the autonomous vehicle.

In one embodiment of the system in accordance with the invention for autonomously controlling an autonomous vehicle, the static planning device has a static map unit, which is configured to provide the static planning unit with map data for determining the current traffic situation in the region of the static detector unit. The map data is advantageously available to the static tactical planning unit at any time and independently of transmission via a communication network.

In a further embodiment of the system in accordance with the invention for autonomously controlling an autonomous vehicle, the autonomous vehicle comprises a state determination unit for determining the ego state of the autonomous vehicle. The ego state of the autonomous vehicle indicates the current dynamic state of the autonomous vehicle. For example, the vehicle's ego state comprises its own position, speed, direction of travel, and the current fuel reserves and fuel requirement of the autonomous vehicle. This data is also input into the tactical planning of the autonomous vehicle's driving.

The autonomous vehicle can also comprise a strategy planning unit for determining the driving strategy to be specified. The driving strategy includes the driving route of the autonomous vehicle.

In addition, the static planning device can also comprise a strategy specification unit, which is configured to communicate with the strategy planning unit and, in coordination with the strategy planning unit of the autonomous vehicle, to determine a driving strategy as a basis for the driving tactics to be statically generated.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following the invention is explained once again in more detail with reference to the attached figures and based on exemplary embodiments, in which:

FIG. 1 shows a schematic representation of a conventional system for controlling an autonomous vehicle;

FIG. 2 shows a schematic representation of a system for controlling an autonomous vehicle, in accordance with an exemplary embodiment of the invention;

FIG. 3 shows a flowchart that illustrates the learning process of the learning unit mentioned in connection with FIG. 2; and

FIG. 4 shows a flowchart that illustrates a method for controlling an autonomous vehicle, in accordance with an exemplary embodiment of the invention.

### DETAILED DESCRIPTION OF THE EXEMPLARY EMBODIMENTS

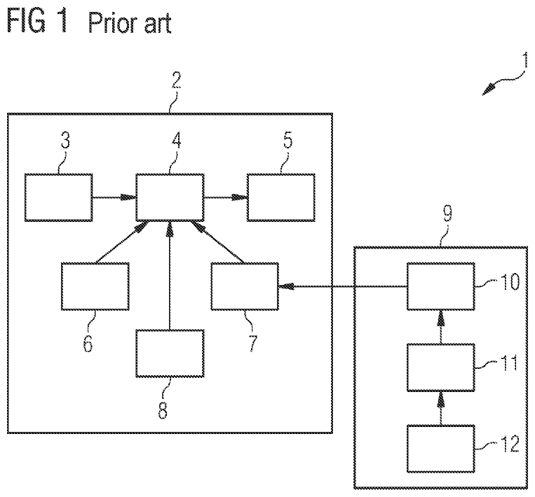

FIG. 1 shows a conventional system 1 for autonomously controlling an autonomous vehicle 2. The system 1 comprises an autonomous vehicle 2. The autonomous vehicle 2 comprises a strategy unit 3, which is configured to define a driving strategy for the autonomous vehicle. The driving strategy comprises, for example, a driving route that the autonomous vehicle 2 is to follow. To implement this driving strategy, the autonomous vehicle 2 comprises a unit 4 for tactical planning. The unit 4 for tactical planning comprises tactical behaviors that can be used in specific situations. The tactical behaviors can be generated by AI processes, such as machine learning. Part of the autonomous vehicle 2 is also a motion control unit 5, which generates and outputs commands to control the movement of the autonomous vehicle 2 based on a defined driving tactic. For example, the motion control unit 5 controls the engine power or a braking maneuver or the steering of the autonomous vehicle 2 to implement the driving tactic defined by the unit 4 for tactical planning. The autonomous vehicle 2 also comprises a map unit 6, which comprises a high-resolution map and provides detailed information about the road on which the autonomous vehicle 2 is driving. This detailed information includes, for example, the road width, turning connections, and the number of lanes. Furthermore, the autonomous vehicle also has a situation determination unit 7 that is used to detect the current traffic situation with the aid of sensors. Another part of the autonomous vehicle 2 is a self-monitoring unit 8, which determines the ego state of the autonomous vehicle 2.

The conventional system 1 for autonomously controlling an autonomous vehicle 2 also comprises an infrastructure-based detector unit 9, which is configured to provide the autonomous vehicle 2 with information about the current traffic situation. For this purpose, the infrastructure-based detector unit 9 comprises a plurality of sensors 12, which acquire sensor data from the environment of the infrastructure-based detector unit 9. The sensor data is transmitted from the sensors 12 to a feature extraction unit 11, which is also part of the detector unit 9. The feature extraction unit extracts features from the sensor raw data, such as objects, edges, and/or textures. The extracted features M are transmitted to an object detection and classification unit 10, which detects and classifies the objects and determines their trajectories based on the features. The detected objects and their trajectories are transmitted to the situation determination unit 7 of the autonomous vehicle 2. The situation determination unit 7 uses the data obtained from the infrastructure-based detector unit 9 to improve the detection of the environment and to determine the current traffic situation of the vehicle 2 more accurately on the basis of the environmental information. The information about the current traffic situation is used by the unit 4 for tactical planning to determine the current driving planning tactic.

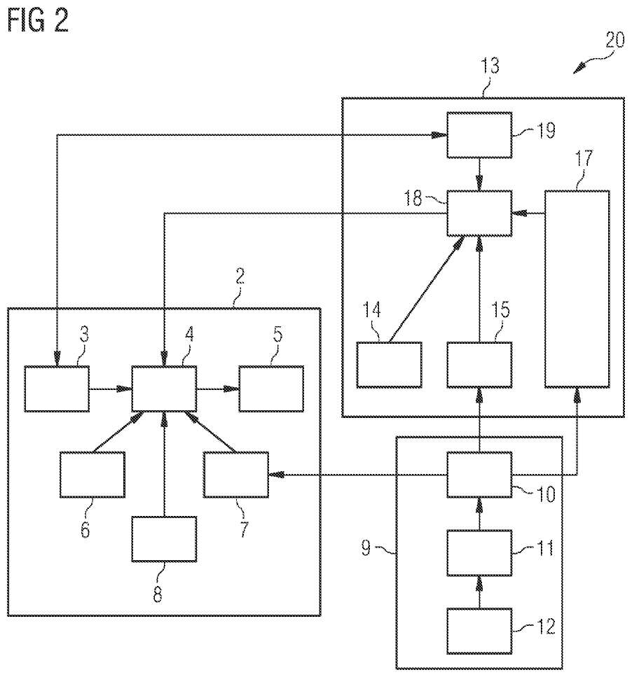

FIG. 2 shows a schematic representation of a system for controlling an autonomous vehicle 2, in accordance with an exemplary embodiment of the invention. The system 20 shown in FIG. 2 differs from the conventional arrangement 1 shown in FIG. 1 by having an additional infrastructure-based planning device 13. The additional infrastructure-based planning device 13 has a localized tactical planning unit 18. The localized tactical planning unit 18 receives map data from an infrastructure-based map unit 14 and receives detected and/or classified objects and their trajectories from a static traffic situation analysis unit 15 for determining a current localized traffic situation. The static traffic situation analysis unit 15 receives the detected and/or classified objects and their trajectories for determining a current localized traffic situation from the localized infrastructure-based detector unit 9. The determined localized traffic situation is transmitted from the static traffic situation analysis unit 15 to the localized tactical planning unit 18 mentioned above, which is also part of the infrastructure-based planning device 13. Part of the infrastructure-based planning device 13 is also a learning unit 17, which learns and can recognize successful driving tactics on the basis of the detected objects of the object recognition and classification unit 10 via machine learning. The above-mentioned localized tactical planning unit 18 then determines tactics based on the successful tactics determined by the learning unit 17 of the map data received from the infrastructure-based map unit 14 and of the detected and/or classified objects and their trajectories received from the static traffic situation analysis unit 15. The determined tactic is transmitted to the tactical planning unit 4 of the autonomous vehicle 2. The infrastructure-based planning device 13 also has a static strategy specification unit 19, which receives a strategy specification from the strategy unit 3 of the autonomous vehicle 2 and transmits the specification to the aforementioned localized tactical planning unit 18. Based on this strategy specification, the localized tactical planning unit 18 determines its proposed tactic, which it transmits to the tactical planning unit 4 of the autonomous vehicle 2.

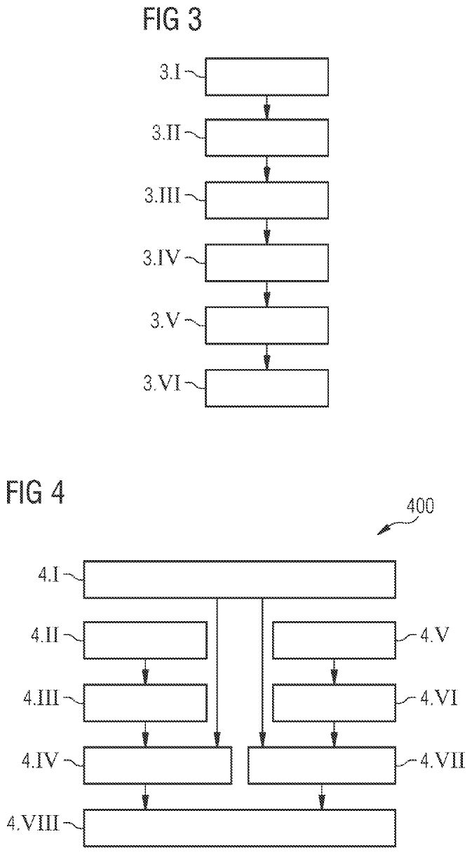

FIG. 3 shows a flowchart that illustrates the learning process of the learning unit 17 mentioned in connection with FIG. 2. The learning unit 17 is used to learn driving tactics and to optimize the selection of driving tactics depending on a statically determined traffic situation. Such a learning procedure can advantageously be used to filter out the tactics that are successful for a specific topology of a local infrastructure region and to make them available to vehicles approaching the infrastructure region. In step 3.I, object information about a current traffic situation is first collected on the infrastructure side. In step 3.II, this object information is used on the infrastructure side to determine a current traffic situation. Vehicles and their movements are also detected in this step. In addition, in step 3.III the driving tactic actually selected by a vehicle is recorded. The driving tactic is determined based on the determined object information. For example, the reaction of a vehicle to a current traffic situation is recorded. In step 3.IV the driving tactic actually implemented by a vehicle is evaluated. This evaluation is based on pre-defined key performance indicators (KPIs). The determined driving tactics and their evaluation results are stored in a database of the learning unit 17 in step 3.V. Finally, in step 3.VI, the tactical planning unit 18 is trained by the learning unit 17. In other words, the result of the learning process is an improved or adapted version of the tactical planning unit 18.

FIG. 4 shows a flowchart 400 that illustrates a method for controlling an autonomous vehicle in accordance with an exemplary embodiment of the invention. The method is implemented using the system 20 illustrated in FIG. 2.

In step 4.I, a driving strategy for a vehicle is first defined. This driving strategy comprises, for example, the driving route of the vehicle. In step 4.II, a vehicle then detects object information around the vehicle. In step 4.III, this object information is used by the vehicle to determine a current traffic situation. Based on the traffic situation determined, the vehicle defines a mobile-generated driving tactic in step 4.IV. In addition, in step 4.V, object detection is carried out on the infrastructure side and object information is generated. In step 4.VI, this object information is used on the infrastructure side to determine a current traffic situation. Based on the traffic situation determined in step 4.VI, in step 4.VII a driving tactic is statically generated based on the driving tactics generated in the learning process illustrated in FIG. 3. Finally, in step 4.VIII one of the driving tactics generated in step 4.IV and step 4.VII is selected. As already mentioned, the selection of the driving tactic can be based on predefined criteria such as safety, time required to reach a driving destination, or economic or environmental aspects. In this way, not only the tactical planning itself, but also its development can be based on a broader dataset.

Finally, it is pointed out once again that the methods and devices described above are merely preferred exemplary embodiments of the invention and that the invention can be varied by the person skilled in the art without departing from the scope of the invention, insofar as it is specified by the claims. For the sake of completeness, it is also pointed out that the use of the indefinite article “a” or “an” does not exclude such features from multiple from also being present more than once. Similarly, the term “unit” does not exclude the possibility that it consists of a plurality of components, which may also be spatially distributed.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A system for autonomously controlling an autonomous vehicle, comprising:
a static detector device for statically generating object information from an environment of the static detector device; and
a static planning device which is configured to determine a statically generated driving tactic for the autonomous vehicle based on the generated object information, the autonomous vehicle, comprising:
a mobile strategy unit for generating a driving strategy of the autonomous vehicle; and
a mobile planning unit for determining a driving tactic based on the predefined driving strategy, a current driving situation around the autonomous vehicle and the driving tactic determined by the static planning device.

14. The system as claimed in claim 13, wherein the static planning device comprises:
a learning unit which generates successful driving tactics based on the object information via machine learning; and
a static planning unit which determines the statically generated driving tactic for the autonomous vehicle based on the successful driving tactics.

15. The system as claimed in claim 13, wherein the autonomous vehicle comprises a mobile, on-board traffic situation analysis unit which is configured to determine the current traffic situation around the autonomous vehicle based on the object information generated by the static detector unit.

16. The system as claimed in claim 13, wherein the autonomous vehicle comprises a mobile, on-board traffic situation analysis unit which is configured to determine the current traffic situation around the autonomous vehicle based on the object information generated by the static detector unit.

17. The system as claimed in claim 13, wherein the static planning device comprises a static traffic situation analysis unit which is configured to determine a current traffic situation in the region of the static detector unit based on the object information generated by the static detector unit and to transmit information about the current traffic situation to the static planning unit.

18. The system as claimed in claim 13, wherein the autonomous vehicle comprises a mobile map unit which is configured to provide the mobile planning unit with map data for determining the current traffic situation around the autonomous vehicle.

19. The system as claimed claim 13, wherein the static planning device has a static map unit, which is configured to provide the static planning unit with map data for determining the current traffic situation in the region of the static detector unit.

20. The system as claimed in claim 13, wherein the autonomous vehicle includes a state determination unit for determining an ego state of the autonomous vehicle.

21. The system as claimed in claim 13, wherein the autonomous vehicle comprises a strategy planning unit for determining a driving strategy to be specified for the autonomous vehicle.

22. The system as claimed in claim 21, wherein the static planning device comprises a strategy specification unit which is configured to communicate with the strategy planning unit and to determine, in coordination with the strategy planning unit, a driving strategy as a basis for the driving tactics to be statically generated.

23. A method for autonomously controlling an autonomous vehicle, the method comprising:
statically generating object information from an environment of a static detector unit;
generating successful driving tactics based on the statistically generated object information by machine learning and deploying the generated successful driving tactics for static tactical planning; and
statically determining a driving tactic for the autonomous vehicle based on the statistically generated object information and the deployed the generated successful driving tactics, mobile determination of a driving tactic of the autonomous vehicle based on a specified driving strategy, data acquired from mobile sensors, and the statically determined driving tactic.

24. A computer program product having a computer program which is loadable directly into a storage device of a system for autonomously controlling an autonomous vehicle, having program sections to execute the method as claimed in claim 23 when the computer program is executed in the system.

25. A non-transitory computer-readable medium encoded with program sections which, when executed by a computer unit, cause autonomous control of an autonomous vehicle, the program sections comprising:
program code for statically generating object information from an environment of a static detector unit;
program code for generating successful driving tactics based on the statistically generated object information by machine learning and deploying the generated successful driving tactics for static tactical planning; and
program code for statically determining a driving tactic for the autonomous vehicle based on the statistically generated object information and the deployed the generated successful driving tactics, mobile determination of a driving tactic of the autonomous vehicle based on a specified driving strategy, data acquired from mobile sensors, and the statically determined driving tactic.
